(19) United States
(12) Patent Application Publication
(10) Pub. No.: US 2006/0265656 A1
(43) Pub. Date: Nov. 23, 2006

(54) System and method for managing information handling system service communication

(76) Inventors: Timothy M. Lambert, Austin, TX (US); Pedro Lopez, Austin, TX (US)

Correspondence Address: HAMILTON & TERRILE, LLP, P.O. BOX 203518, AUSTIN, TX, 78720, US

(21) Appl. No.: 11/134,966

(22) Filed: May 23, 2005

(51) Int. Cl. G06F 17/00

(52) U.S. Cl. 715/705

(57) ABSTRACT

A technical support button accepts user activation to request a technical support session for an information handling system. For instance, activation of technical support sends an electronic message, such as an e-mail or instant message, to a technical support site that includes technical support information for establishing a technical support session, such as identification and diagnostics information. The technical support session is established through the information handling system to aid a technical support agent in investigating the system directly while communicating with the user of the system. For instance, VoIP communication is established through a management subsystem that operates on auxiliary power so that a technical support session is supported even if the information handling system is powered down or inoperative.

### BACKGROUND OF THE INVENTION

1. Field of the Invention

The present invention relates in general to the field of information handling systems, and more particularly to a system and method for managing information handling system service communication.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generally operate with good reliability, however, for information handling systems that perform some critical functions, such as communication, additional components are often added to enhance operating reliability. For instance, server information handling systems sometimes include a management subsystem to monitor and adjust system operations. One example of a management subsystem is a remote access card (RAC) that is integrated within a server information handling system. A typical RAC is essentially a miniature information handling system on a card complete with a relatively powerful processor, such as a 333 MHz 8086 processor, and with integrated peripherals, such as Ethernet, USB, AC'97 audio, and extensive local FLASH and RAM. Generally, the RAC operates on auxiliary power and may thus operate normally even if its associated information handling system is powered down or otherwise not operating. An independent RAC provides remote access to perform functions at the information handling system including system resets and reboots initiated through network commands or other functions that diagnose and manage the server information handling system. The network commands are sent through an out-of-band network interface card to support independent RAC operation using a variety of communication protocols, such as virtual KVM over IP, virtual media and IPMI.

An advantage of having a RAC loaded on a server information handling system is that information technology professionals can perform management functions on the server from a location distal to the server. Similarly, the manufacturer of the server information handling system obtains direct access to the system for providing analysis of system performance or other technical assistance. Although a RAC will allow multiple different sources to simultaneously access system management functions, if the different sources need to communicate directly with each other they generally must establish a separate telephone conversation. For instance, if an information technology professional needs technical assistance from the manufacturer, the information technology professional typically calls the manufacture technical help center and, once a conversation between the two has established the identity of the system in question, the technical help center contacts the RAC for management information as needed. The establishment of separate telephone and network communications introduces delay in the technical service process and adds to frustration already generally present with the end user who is dealing with a misbehaving system.

### SUMMARY OF THE INVENTION

Therefore a need has arisen for a system and method which provides audio communication supported through an information handling system management subsystem independent of operation of the information handling system.

In accordance with the present invention, a system and method are provided which substantially reduce the disadvantages and problems associated with previous methods and systems for information handling system management subsystem supported communication. Communication between plural users is supported through the management subsystem, such as to provide technical support to a user of the information handling system from a technical support network location. Automated initiation of communication through the management subsystem, such as a technical support session, is provided by the pressing of a physical support button located at the housing of the information handling system.

More specifically, a technical support subsystem runs on a management subsystem of a server information handling system to provide technical support independent of the operation of the server information handling system. Pressing a support button prompts a support request module to send a message, such as an e-mail or instant message, to request a technical support session. A technical support module establishes the technical support session and couples the session with server management functions of a server management module for integrated system and user technical support. For instance, a Voice over Internet Protocol (VoIP) module establishes voice communication between the end user and a technical support agent while the technical support agent has access to server management functions over the same network communication. Thus, for instance, rather than telling the user to reboot the information handling system, the agent can initiate a reboot and explain to the end user what is happening. A conference module 66 supports communication between multiple network locations so that the management subsystem provides a training tool for distributed users. A session storage module stores technical support sessions for later reference or to record predetermined events, such as an unauthorized access or a system failure.

The present invention provides a number of important technical advantages. One example of an important technical advantage is that multiple users are able to communicate directly with each other through a management subsystem, such as a RAC. Audio communication between users through a management subsystem simplifies servicing of the information handling system with the end-user and technical support having substantially equal and simultaneous access to the management information and control functions. Conventional telephone conversations to coordinate technical assistance are avoided with VoIP communication conveniently associating the information handling system with the request for assistance. On system single button activation of a request for technical assistance provides rapid and direct response for an improved customer experience and reduced time spent by a technical assistant in identifying the end user and the problem. Further, end users are encouraged to initiate technical support sessions with button activation thus increasing the likelihood of a resolution of the end users difficulty with support communication media that are less expensive than telephone support.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a server information handling system having a VoIP enabled independently operable management subsystem with a technical support request button;

FIG. 2 depicts a block diagram of a system for providing technical support with a technical request support button; and

FIG. 3 depicts an example of a graphical user interface for initiating a technical support request.

### DETAILED DESCRIPTION

Technical support coordinated through an information handling system provides multiple media for rapidly and accurately addressing difficulties with the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

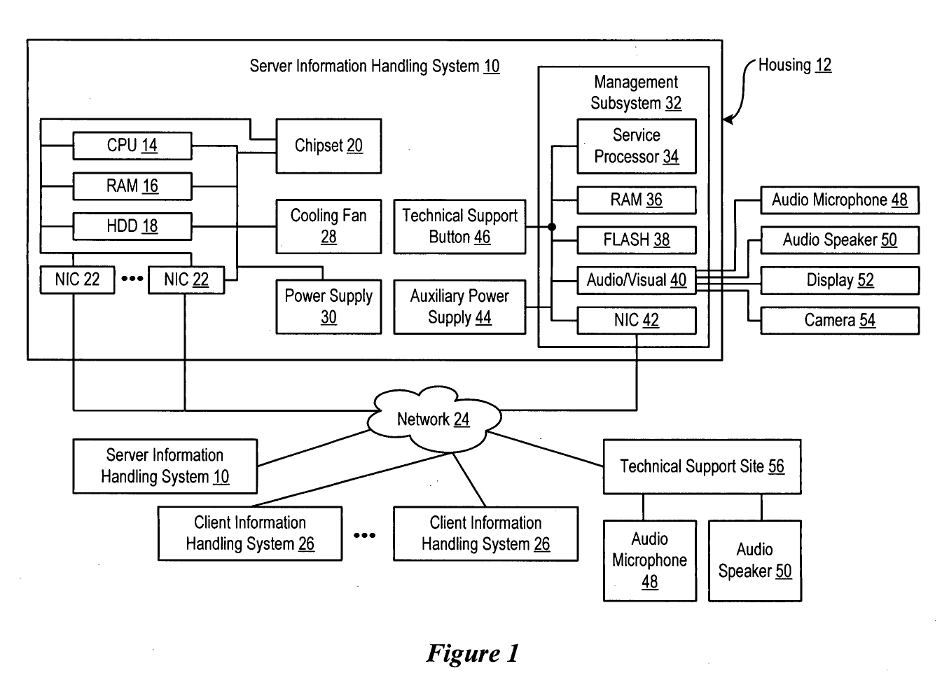

Referring now to FIG. 1, a block diagram depicts a server information handling system having a VoIP enabled independently operable management subsystem with a technical support request button. Server information handling system 10 has plural processing components disposed in a housing 12 including a CPU 14, RAM 16, a hard disk drive (HDD) 18, a chipset 20 and plural network interface cards (NIC) 22. Server information handling system 10 coordinates communication over a network 24 between client information handling systems 26 and other server information handling systems 10, such as in a local area network (LAN) configuration. A cooling fan 28 removes excess heat produced by the processing components and a power supply 30 maintains DC power to the processing components. For improved reliability and remote access, a management subsystem 32 configured as a remote access card is integrated with server information handling system 10. Management subsystem 32 includes a service processor, such as a 333 MHz INTEL 8086 compatible processor, RAM, FLASH memory, an audiovisual card 40, such as an AC'97 compatible card, and a NIC 42 to interface with network 24. Management subsystem 32 operates on an auxiliary power supply 44 to run independently of the rest of information handling system 10. Independent operation of management subsystem 32 allows it to reset, power down and power up information handling system 10. Management subsystem 32 manages the operations of information handling system 10 so that a remote user interfaced through network 24 can exercise full control over system operations.

Management subsystem 32 aids in the coordination of technical support for server information handling system 10 with a technical support button 46 and a variety of peripherals, such as an audio microphone 48, an audio speaker 50, a display 52 and a cameral 54. A user located at server information handling system initiates a request for technical support by pressing button 46 and management subsystem 32 establishes a technical support session through network 24 with a technical support site 56, such as the technical support of the manufacturer of server information handling system 10. Audiovisual card 40 supported by an appropriate driver, such as an AC'97 LINUX driver, allows the end user to interact with a technical support agent using VoIP, much like a conventional telephone. However, coordinating voice communications for technical support through management subsystem 32 allows direct interaction of the technical support agent with server information handling system 10 during the support session, such as to see the display of system 10, virtual storage and control I/O devices. Direct interaction reduces the amount verbal communication needed to identify the system and the technical issues involved, and thus reduces the time involved in coordinating the technical support and the risk of inadvertent errors caused by human communication of identification information and technical codes. Further, the relatively simple and robust management subsystem 32 remains operational on auxiliary power even if server information handling system 10 is inoperative due to a virus infection, an operating system crash, an application failure, or a hardware failure.

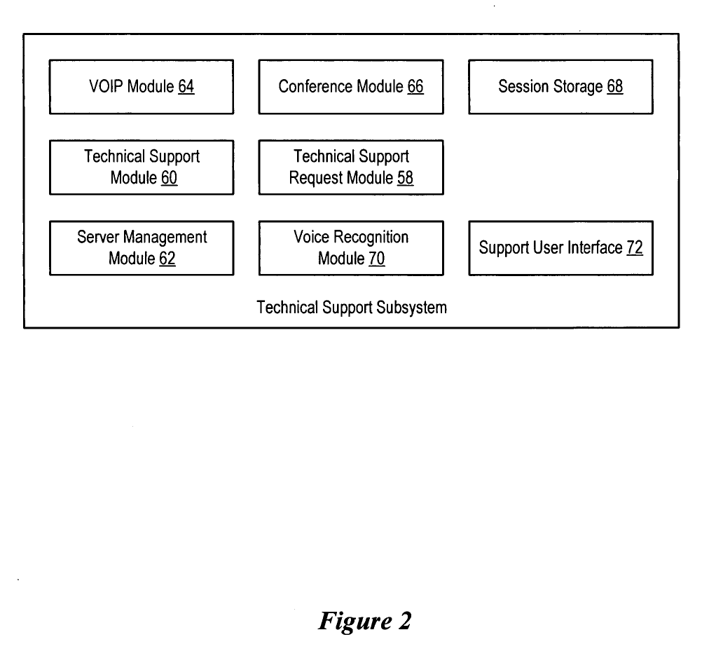

Referring now to FIG. 2, a block diagram depicts a system for providing technical support with a technical request support button. The functional modules depicted in FIG. 2 run on service processor 34 which manages coordination of management subsystem 32 hardware components under, for instance, a LINUX operating system kernel, such as to open and maintain network socket connections. Upon pressing of support button 46, a technical support request module 58 initiates a technical support session with a technical support site 56 through network 24. For instance, technical support request module sends an electronic message, such as an e-mail or an instant message, which includes information for technical support site 56 to apply in order to efficiently assign the request to an appropriate technical support agent. For instance, technical support request module 58 includes a unique identifier with the message to identify the type of information handling system, the level of service and any automated error tracking information that is available for review by the agent. Technical support site 56 replies to the message with session information to establish a technical support session, such as an IP address to establish VoIP communication. A technical support module 60 establishes the technical support session with the session information and coordinates retrieval of management information related to the operations of server information handling system 10 from a server management module 62. For instance, technical support module 60 coordinates communication of diagnostics information tracked by server management module 62 to technical support site 56 in addition to the VoIP communication. Coordination of management information and voice communication through a common network communication allows technical support site 56 to more quickly and accurately gather information for use by an agent to provide technical support.

A VoIP module 64 establishes and maintains VoIP communication for the technical support session and a conference module 66 coordinates communication between plural locations. Depending upon the processing components of management subsystem 32 and the available bandwidth, technical support sessions may include between 4 and 16 different locations simultaneously. Thus, for instance, a technical support session provides a tool for corporate training for the use of server information handling system 10 with dispersed participants, whether or not a manufacturer technical support site is involved. A session storage module 68 provides storage for a support session, such as storage in MP3 format, so that an end user may subsequently refer to information or solutions provided by the support session. Similarly, session recording may be initiated at the occurrence of a predetermined event, such as an operating system failure or an unauthorized access to the system. One advantage of a voice technical support session is that remote participants to the session can hear system operations, such as beeps or whining fans, along with viewing system video. In one embodiment, a voice recognition module 70 operates during a support session to accept user voice commands for managing server operations, such as reboot, shutdown, virtual drive online, and boot to BIOS setup. Audio and visual interactions with end users are managed by a support user interface 72. For instance, in addition to presenting information at a display, audible system management information may be provided, such as a generated voice to indicate time until support is available or that an access is not authorized. In one embodiment, “headless” servers are managed by voice information provided through external audio jacks so that a display device is not needed.

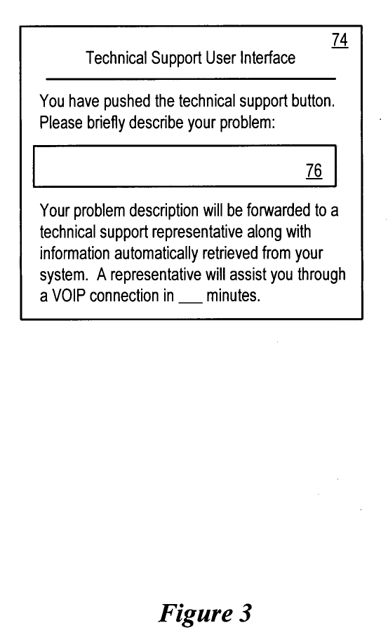

Referring now to FIG. 3, an example is depicted of a graphical user interface 74 for initiating a technical support request. User interface 74 is automatically generated at the pressing of the support button at the housing of server information handling system 10. A dialog box 76 allows a user to describe the type of technical support sought and provides the description with system management information automatically generated for the technical support site, such as a unique identifier for the system and any diagnostics indicative of a particular system failure. The presentation of the dialog box before a request is sent helps avoid inadvertent activations. The technical support information is sent as an e-mail or instant message, and a reply message from the technical support site populates the wait time expected before a technical support agent becomes available. Advantageously, a technical support agent may be able to determine a solution for the difficulty without even establishing a voice link, thus reducing the time and cost involved in providing the technical support. For this and other reasons, a technical support button provided on an information handling system is helpful even where the information handling system does not have a management subsystem that runs independently. Add-on technical support subsystems may be included by inserting an appropriately configured card into an existing system PCI slot or similar interface.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
plural processing components disposed in the housing and operable to process information;
a technical support button disposed at the housing and operable to accept a physical user input that requests technical support; and
a technical support request module running on one or more of the processing components and interfaced with the technical support button, the support request module operable to communicate over a network with a technical support site to request a technical support session upon activation of the technical support button.

2. The information handling system of claim 1 further comprising a technical support module interfaced with the technical support request module, the technical support module operable to maintain the technical support session between the technical support site and the user.

3. The information handling system of claim 2 further comprising a VoIP module running on one or more of the processing components and operable to communicate audio information over the network with the Internet Protocol, wherein the technical support session comprises VoIP communication.

4. The information handling system of claim 1 wherein the technical support request module sends a technical support request as an e-mail communication.

5. The information handling system of claim 1 wherein the technical support request module sends a technical support request as an instant message.

6. The information handling system of claim 1 wherein the processing components comprise a management subsystem having an auxiliary power supply, the technical support request module running on the management subsystem.

7. The information handling system of claim 6 further comprising:
a microphone associated with the management subsystem and operable to receive audible communication;
a speaker associated with the management subsystem and operable to play audible communication; and
a VoIP module running on the management subsystem and operable to communicate VoIP information from the microphone to the technical support site and information from the technical support site to the speaker.

8. The information handling system of claim 1 wherein the technical support button comprises a logo associated with the manufacturer of the information handling system.

9. An information handling system server comprising:
plural processing components operable to process information and communicate information with a network;
a management subsystem operable to run independent of the processing component, the management subsystem having a service processor, an audio card and a network interface card;
a microphone interfaced with the audio card and operable to receive audio sounds;
a speaker interfaced with the audio card and operable to play audio sounds; and
a VoIP module running on the management subsystem and operable to support VoIP communication with the microphone and speaker through the network interface card.

10. The information handling system of claim 9 further comprising an auxiliary power supply interfaced with the management subsystem and operable to power the management subsystem with the processing components powered down.

11. The information handling system of claim 9 further comprising a technical support module operating on the management subsystem and interfaced with the VoIP module, the technical support module operable to establish VoIP communication with a technical support network site and to provide technical support information to the technical support network site.

12. The information handling system of claim 11 further comprising:
a support button operable to accept a physical user input to request technical support; and
a technical support request module interfaced with the support button and the technical support module, the technical support request module operable to detect a request for technical support and to initiate communication with the technical support network site.

13. The information handling system of claim 12 wherein the support button comprises a manufacturer logo.

14. The information handling system of claim 12 wherein the technical support request module initiates communication with an instant message.

15. The information handling system of claim 12 wherein the technical support request module initiates communication with an e-mail message.

16. A method for providing technical support to an information handling system, the method comprising:
pressing a support button at the information handling system to request technical support;
automatically initiating a request for technical support in response to the pressing of the support button; and
automatically establishing network communication with a technical support site with the information handling system to obtain technical support.

17. The method of claim 16 wherein automatically establishing network communication comprises establishing VoIP communication between the information handling system and a technical support representative.

18. The method of claim 16 wherein automatically initiating a request comprises:
presenting a user interface at the information handling system;
receiving technical support request information at the user interface;
sending the technical support request information to the technical support site; and
applying the technical support information to route the technical support request.

19. The method of claim 18 wherein automatically establishing network communication comprises establishing communication between a technical support module and the technical support site, the technical support module providing access to the technical support site of management information stored on the information handling system.

20. The method of 16 further comprising:
storing technical support communication at the information handling system; and
retrieving the technical support communication at the information handling system.
